(19) United States
(12) Patent Application Publication
(10) Pub. No.: US 2013/0311396 A1
(43) Pub. Date: Nov. 21, 2013

(54) JOB-BASED SUCCESSION PLANS AND A HIERARCHICAL VIEW OF THE SUCCESSION PLAN

(71) Applicants: Kenneth Klaus, Dublin, CA (US); Arvin Kan, Pleasanton, CA (US); Pradeep Gupta, Hyderabad (IN); Hsing Huang, Pleasanton, CA (US); Chau Ha Leung, Castro Valley, CA (US); Kristine Lois Van der Ploeg, The Villages, FL (US); Marcelyn Van Houten, Walnut Creek, CA (US)

(72) Inventors: Kenneth Klaus, Dublin, CA (US); Arvin Kan, Pleasanton, CA (US); Pradeep Gupta, Hyderabad (IN); Hsing Huang, Pleasanton, CA (US); Chau Ha Leung, Castro Valley, CA (US); Kristine Lois Van der Ploeg, The Villages, FL (US); Marcelyn Van Houten, Walnut Creek, CA (US)

(73) Assignee: Oracle International Corporation, Redwood Shores, CA (US)

(21) Appl. No.: 13/472,122

(22) Filed: May 15, 2012

(51) Int. Cl. G06Q 10/00

(52) U.S. Cl. 705/348

(57) ABSTRACT

A system and method for facilitating succession management in an organization, such as an enterprise. The example method includes displaying, at a first level of a hierarchy, a first representation of a position and any incumbent assigned to the position, and illustrating, at a second level of a hierarchy, one or more second representations of one or more candidate successors to the position. The one or more candidate successors are grouped according to an indication of readiness associated with each of the one or more candidate successors. In a specific embodiment, a user option enables changing an indication of readiness assigned to a candidate successor by repositioning the candidate successor into a different readiness group within the hierarchy. Displayed data supporting candidate-readiness determinations includes data pertaining to performance history, experience, qualifications, or talent rating associated with each candidate successor.

### BACKGROUND

The present application relates to software and more specifically to user interface designs and accompanying methods for facilitating job succession management and planning.

Succession management and planning software is employed in various demanding applications, including enterprise, government, and military, and academic applications. Such applications often demand user friendly and insightful software that facilitates anticipating, planning for, and minimizing adverse effects of job/position vacancies and changes.

Conventionally, an organization, such as an enterprise, may include a hierarchal organizational structure, depictable via an organization chart. Succession management software often relies upon the structure of the organization chart and accompanying details/attributes associated with existing employees, i.e., incumbents, detailed in the organization chart to provide suggestions and insight for succession management planning.

However, such conventional succession management software may provide unwieldy organizations of data, which may obscure critical insight needed for proper replacement of an incumbent or fulfillment of a job/position vacancy with a candidate successor.

### SUMMARY

An example method facilitates succession management in an organization, such as an enterprise. The example method includes displaying, at a first level of a hierarchy, a first representation of a position and any incumbent assigned to the position, and illustrating, at a second level of a hierarchy, one or more second representations of one or more candidate successors to the position, wherein the second representations are grouped according to an indication of readiness associated with each of the one or more candidate successors.

In a specific embodiment, the method further includes displaying one or more indications of readiness of a candidate successor. The one or more indications of readiness include data pertaining to performance history, experience, qualifications, or talent ratings associated with each candidate successor.

A first user option enables a user to change an indication of readiness assigned to a candidate successor by repositioning the candidate successor into a different readiness group within the hierarchy Candidates are arranged in the order of their readiness from left to right. Thus the candidate on the left would be considered “most ready.”

The specific example method further includes providing a second user option to associate a candidate with an incumbent. A third user option enables a user to associate a candidate with a position, wherein the position may be associated with multiple incumbents on an organization chart.

An additional user option enables a user to continue to expand the hierarchy to view any level of the hierarchy. Subsequent levels of the hierarchy illustrate one or more candidate successors to positions or incumbents held by persons corresponding to representations of candidate successors at a prior level of the hierarchy.

Another user option enables a user to select plural representations of persons displayed in the hierarchy for comparison and to view associated comparison data. The comparison data may be illustrated via one or more analytics, such as graphs, charts, and other visualizations. Example analytics include a competency gap graphic, a performance history visualization illustrating performance history associated with compared candidate successors, and a graph depicting components of talent scores associated with compared candidate successors.

Another user option enables a user to configure a succession management plan associated with the hierarchy to apply to plural positions having a similar function as a position specified for the succession management plan associated with the hierarchy. An additional user option enables a user to configure a succession management plan associated with the hierarchy to apply to a specific incumbent indicated in a succession management plan.

Hence, certain embodiments discussed herein facilitate viewing and managing a succession plan via a hierarchy that provides key insight into the readiness of candidate successors to a given position or incumbent in an organization. Embedding access to candidate readiness analysis tools and associated detailed analytics within a display of the hierarchy may facilitate rapid candidate-readiness determinations.

Furthermore, providing user options to configure a succession plan hierarchy to apply to all jobs or positions of similar names may obviate the need for redundant candidate readiness determinations. Conventionally, existing succession management software often treated candidate successors as attributes of incumbents. In enterprises with multiple incumbents at similar positions, identifying candidate successors to replace each incumbent was excessively redundant and tedious. Certain embodiments disclosed herein overcome such shortcomings with conventional succession management software.

In addition, by enabling a succession plan to be associated with one or more jobs or positions, as opposed to only an incumbent, fewer succession plans may be required, and each succession plan may have a longer life expectancy. Furthermore, additional opportunities available to a given candidate successor may become more readily visible.

In addition, employing a hierarchical view of a succession plan to highlight the relative readiness of the candidate successors, as disclosed herein, may further facilitate tracking effectiveness of succession management and candidate development processes.

A further understanding of the nature and the advantages of particular embodiments disclosed herein may be realized by reference of the remaining portions of the specification and the attached drawings.

### BRIEF DESCRIPTION OF THE DRAWINGS

FIG. 1 is a diagram illustrating a first example embodiment of a system for facilitating succession management in an example enterprise computing environment.

FIG. 2 is diagram of a first example user interface display screen adapted for use with the embodiment of FIG. 1.

FIG. 3 is a diagram of a second example user interface display screen adapted for use with the embodiments of FIGS. 1-2.

FIG. 4 is a diagram of a third example user interface display screen adapted for use with the embodiments of FIGS. 1-3.

FIG. 5 is a flow diagram of an example method adapted for use with the embodiments of FIGS. 1-4.

### DETAILED DESCRIPTION OF EMBODIMENTS

Although the description has been described with respect to particular embodiments thereof, these particular embodiments are merely illustrative, and not restrictive.

For example, while various embodiments herein are discussed with respect to user interface display screens suitable for desktop implementations, embodiments are not limited thereto. Various embodiments disclosed herein may be adapted for use with virtually any computer based display, including smart phone displays, tablet displays, and so on.

Furthermore, while various user interface controls, such as buttons, tabs, sliders, and so on, are shown, other types of user interface controls may be employed in addition to or instead of such controls, without departing from the scope of the present teachings.

For the purposes of the present discussion, a user interface control may be any displayed element or component of a user interface display screen, which is adapted to enable a user to provide input. Examples of user interface controls include buttons, drop down menus, menu items, hyperlinks, and so on.

For clarity, certain well-known components, such as hard drives, processors, operating systems, power supplies, and so on, have been omitted from the figures. However, those skilled in the art with access to the present teachings will know which components to implement and how to implement them to meet the needs of a given application.

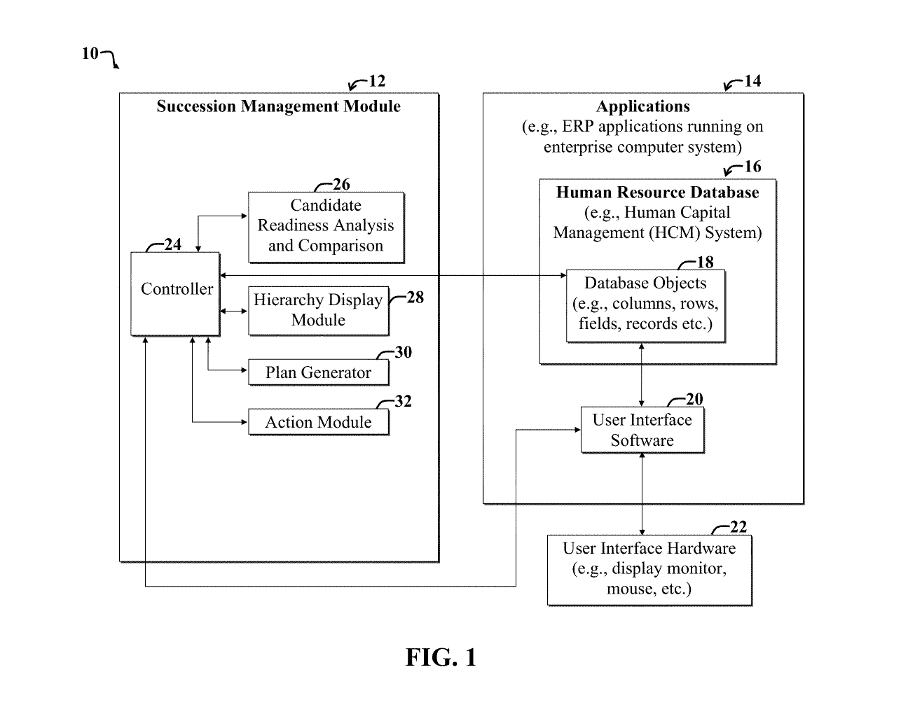

FIG. 1 is a diagram illustrating a first example embodiment of a system 10 for facilitating succession management in an example enterprise computing environment.

For the purposes of the present discussion, the term ‘succession management’ may refer to any process involving making provisions for or performing actions pertaining to the development, replacement, and/or repositioning of people and/or jobs, i.e., positions or roles, within an organization. An organization may be any entity comprising an association of people, such as an enterprise, university, government, nonprofit organization, small business, and so on.

A position may be any job, role, or other work assignment within an organization. Examples of positions may include manager, chief executive officer, vice president, salesperson, and so on. Exact names of positions within an organization vary, and various embodiments discussed herein are not limited to particular positions or types of positions.

An incumbent may be any person that is currently holding a position within an organization. A candidate, also called candidate successor or potential successor, may be any person being considered to fulfill or assume a position when the position becomes available. A representation of a person, such as an incumbent or candidate, in a hierarchy, may be any displayed collection of data or graphical representation(s) of a computing object associated with the person. In certain instances herein, such a representation of a person may be referred to as the person. For example, a representation of an incumbent in a hierarchy may simply be called the incumbent in the hierarchy.

A hierarchy may be any arrangement of items, e.g., data objects, names, values, categories, and so on. The items may be ordered or positioned such that they exhibit superior or subordinate relationships with related items in a data set. A hierarchy may refer to a displayed representation of data items or may refer to data and accompanying relationships existing irrespective of the representation. Hierarchal data may be any information characterizing a hierarchy.

Enterprise personnel may include any persons associated with an enterprise. An enterprise may be any organization of persons, such as a company, non-profit organization, university, government, and so on. Examples of enterprise personnel include employees, independent contractors, managers, investors, and so on.

An enterprise computing environment may be any computing environment used for a business or organization. A computing environment may be any collection of computing resources used to perform one or more tasks involving computer processing. An example enterprise computing environment includes various computing resources distributed across a network and may further include private and shared content on Intranet Web servers, databases, files on local hard discs or file servers, email systems, document management systems, portals, and so on.

For the purposes of the present discussion, ERP software may be any set of computer code that is adapted to facilitate managing resources of an organization. Example resources include Human Resources (HR) (e.g., enterprise personnel), financial resources, assets, employees, and so on, of an enterprise. The terms “ERP software” and “ERP application” may be employed interchangeably herein. However, an ERP application may include one or more ERP software modules or components, such as user interface software modules or components.

Enterprise software applications, such as Customer Relationship Management (CRM), Business Intelligence (BI), Enterprise Resource Planning (ERP), and project management software, often include databases with various database objects, also called data objects or entities. A database object, also called a computing object herein, may be any collection of data, such as data pertaining to a particular financial account, asset, employee, contact, and so on. Examples of computing objects include, but are not limited to, records, tables, or other database entities corresponding to employees, customers, business resources, and so on.

The example system 10 includes various Enterprise Resource Planning (ERP) applications 14, including a Human Resource (HR) database 16 and accompanying user interface software 20. The human resource database 16 includes various database objects 18, such as records, tables, and/or profiles corresponding to enterprise personnel, such as employees. The user interface software 20 communicates with user interface hardware 22 and a succession management module 12.

The database objects 18 of the HR database 16 are accessible via the succession management module 12. The succession management module 12 includes a controller 24, which communicates with the user interface software 20 of the ERP applications 14 and the HR database 16. The succession management module 12 further includes a candidate readiness analysis and comparison module 26, a hierarchy display module 28, a succession plan generator 30, and an actions module 32, which communicate with the controller 24.

In an example operative scenario, a user, such as an HR manager, employs the user interface hardware 22, such as keyboard, mouse, monitor, and so on, and software 20 to access functionality provided by the succession management module 12.

For example, a user may employ the system 10 to create a succession management plan; to display an associated hierarchy; to view analytics associated with each representation of enterprise personnel and/or associated positions or jobs; and to conduct various actions on representations shown in the hierarchy, as discussed more fully below.

The plan generator 30 includes computer code, i.e., machine readable instructions, for providing various user options to create, configure, and describe a succession management plan.

The hierarchy display module 28 includes computer code for facilitating generating and displaying a hierarchy associated with a corresponding succession management plan generated via the plan generator 30. The hierarchy may include multiple expandable levels, where representations of enterprise personnel (e.g., incumbents and candidate successors) at each level of the hierarchy are grouped in accordance with a readiness determination (e.g., readiness determination made by a user with reference to readiness analysis tools discussed herein) and/or metric assigned to each representation.

The action module 32 includes computer code for facilitating displaying various user options to perform actions on a succession management plan hierarchy. Examples of actions include repositioning representations of candidate successors into different hierarchy readiness groupings, and activating functionality provided by other modules 26, 28, 30 of the succession management module 12. For example, the action module 32 may facilitate providing a user option to activate comparison features of the candidate readiness analysis and comparison module 26.

The candidate readiness analysis and comparison module 26 includes computer code for facilitating displaying various analytics for each incumbent or candidate successor represented in a hierarchy. The analytics may include graphics for illustrating and/or juxtaposing for comparison purposes, performance history, experience and qualifications, talent scores, and so on, of selected representations of candidates or incumbents in a hierarchy, as discussed more fully below.

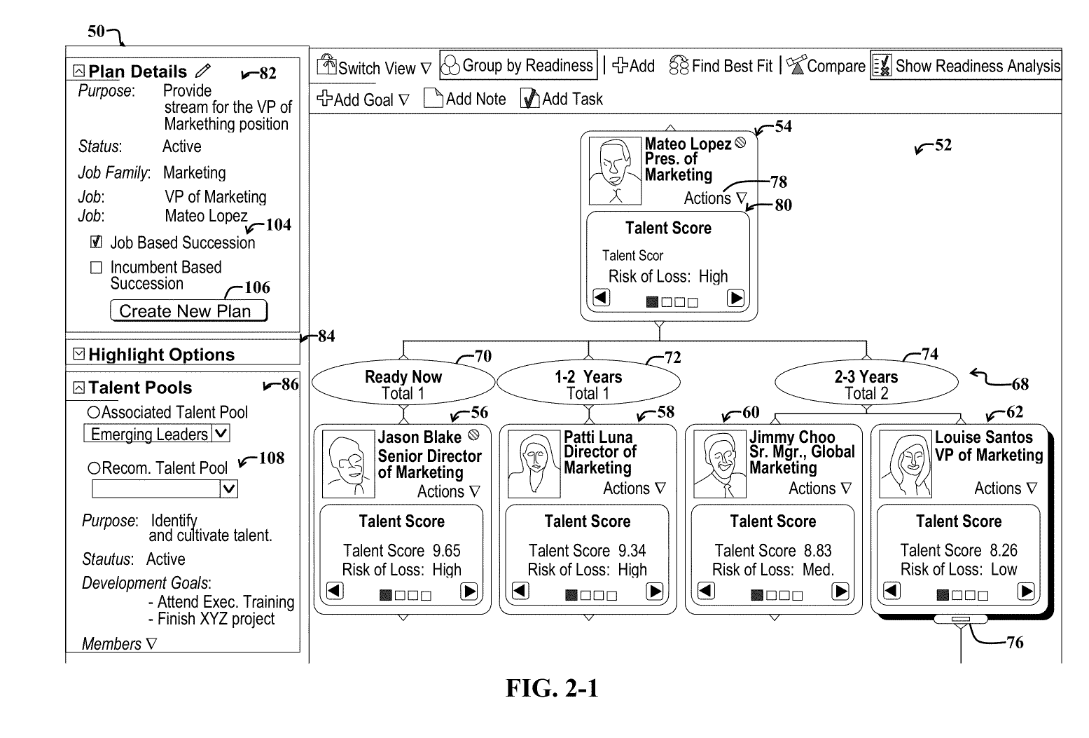

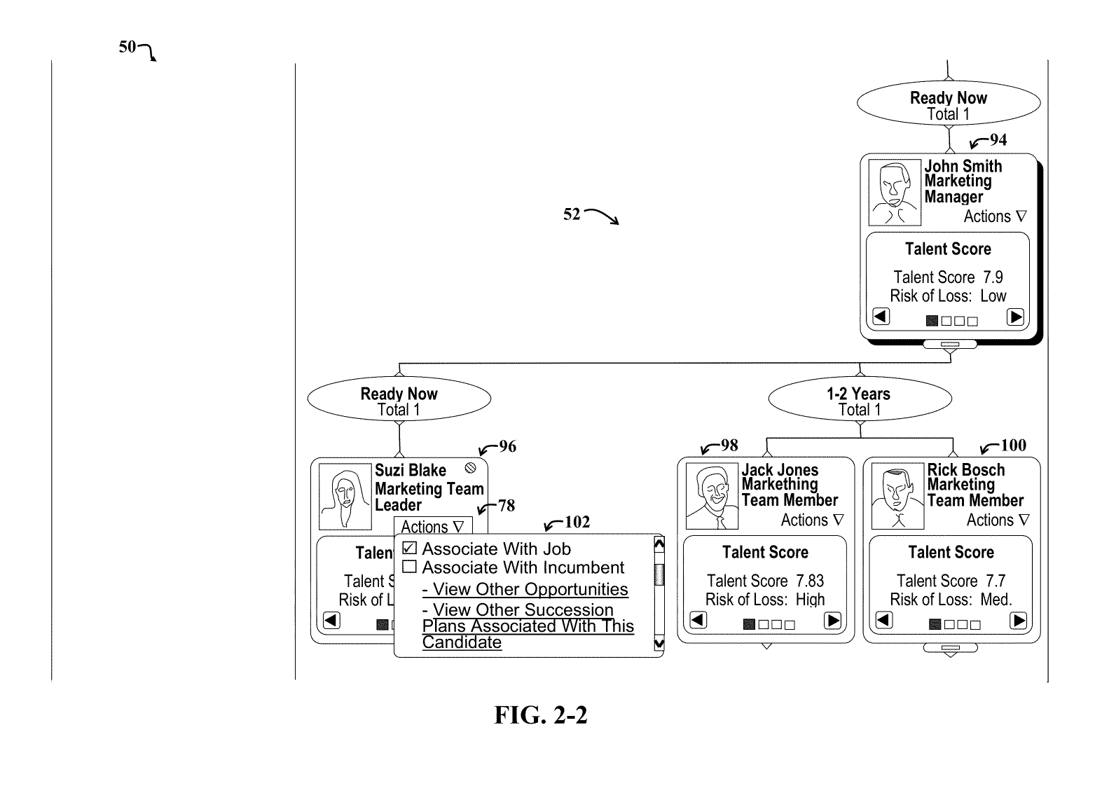

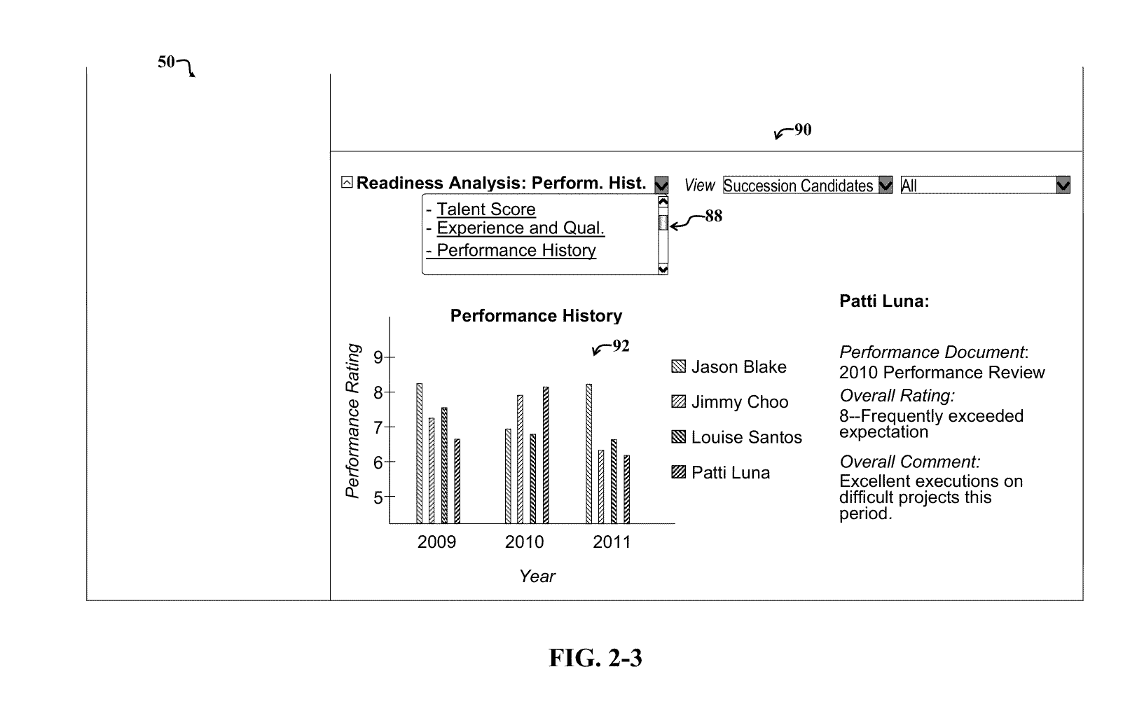

FIG. 2 is diagram of a first example user interface display screen 50 adapted for use with the embodiment of FIG. 1. The example display screen 50 illustrates an example hierarchy 52. The hierarchy 52 includes a first level corresponding to an incumbent 54 and a second level corresponding to various candidate successors 56-62 to the position held by the incumbent 54.

In the present specific embodiment, each representation 54-62 includes an actions drop-down menu 78 and a talent score indicator 80. For the purposes of the present discussion, a talent score may be any metric associated with a rating of a person's talent or ability to perform a particular task or to improve at performing a particular task, set of tasks, job, position, or other activity.

The actions drop-down menu 78 may provide various user options, such as a user option to associated a candidate with a particular incumbent; to associate a candidate with a position; to view other opportunities for a particular candidate; to show other succession plans associated with a candidate, and so on, as shown in an example drop down menu 102 of the action menu 78 (e.g., with reference to FIG. 2-2). Additional example user interface controls 104 provided in a plan details section 82 enable a user, such as an HR manager, to link or otherwise associate the associated succession management plan and accompanying hierarchy 52 with a particular set of positions (e.g., VPs of Marketing). Hence the succession management plan underlying the hierarchy 52 is not restricted to being used for only one incumbent of an enterprise.

The plan detail section 82 further includes various data describing the succession management plan associated with the hierarchy 52. The plan details section 82 further includes an additional user option 106 to create a new succession management plan 106. Note that the various user options 104, 106 of the plan details section 82 and user options 102 of the actions menu 78 (as shown in FIG. 2-2) may be relocated in the user interface display screen 50 or implemented via other mechanisms without departing from the scope of the present teachings. For example, certain plan properties, such as whether a plan is associated with multiple incumbents holding similar positions, may be established during initial configuration and plan setup steps, which may be accessible, for example, upon selection of the create plan button 106.

A highlight options section 84 provides various user options to highlight (such as via color coding or other visual coding) different representations 54-62 based on various user-selectable criteria.

A talent pools section 86 provides various user options to display members of particular talent pools. A user may then selectively add members from selected talent pools to the succession plan 52, such as dragging and dropping representations of talent pool members from the talent pool section 86 to particular positions in the hierarchy 52. Hence, users may build or otherwise manipulate the hierarchy 52 and succession management plan represented thereby, without being confined by the structure of a conventional enterprise organization chart.

The talent pools section 86 includes a user option 108 to have the underlying software, e.g., as represented by the succession management module 12 of FIG. 1, to generate or otherwise determine and recommend talent pools based on predetermined characteristics of persons represented in the hierarchy 52, for example, the talent pools in which other succession candidates are already members. Exact details of the algorithm for recommending talent pools are implementation specific. One skilled in the art with access to the present teachings may readily determine and implement such details without undue experimentation and without departing from the scope of the present teachings.

Additional levels of the hierarchy 52 may be expanded or collapsed, if additional levels exist. For example, user selection of an expand button 76 may cause any additional level of the hierarchy 52 to be displayed. In FIG. 2 (with particular reference to FIG. 2-1), the expand button 76 has been used to display a third level of the hierarchy 52 corresponding to a candidate successor John Smith 94. John Smith 94 is a candidate successor to a VP of marketing position currently held by Louise Santos 62, who is a candidate successor to the President of Marketing position held by Mateo Lopez 54. Similarly, an additional level of the hierarchy 52 below John Smith 94 has been expanded to illustrate a fourth hierarch level corresponding to candidate successors 96-100 to the Marketing Manager position held by John smith 94.

With reference to the second level of the hierarch 52 of FIG. 2, the candidate successors 56 are arranged by indications of readiness 68. In the present example, indications of readiness 68 include a ready now indication 70, a ready in 1-2 years indication 72, and a ready in 2-3 years indication 74. Note that the indicators of readiness 68 refer to specific categorizations of readiness. However, the term ‘indicator of readiness’ may also include additional data or details describing and/or comparing data and/or rating associated with each candidate successor 56-62. Examples of such details are provided in a readiness analysis section 120, as discussed more fully below.

A user, such as an HR manager, may decide that certain persons represented in the hierarchy 52 are ready to be repositioned into different readiness groups within the hierarchy. To reposition, for example Louise Santos, the representation thereof 62 is selected, dragged, and dropped into a new readiness group under a new readiness indication, e.g., one of the other readiness indications 70, 72.

In an alternative implementation, if the hierarchy 52 and associated succession management plan have been globally configured for job based succession rather than incumbent based succession, then any lower hierarchy levels beneath Louise Santos, will not necessarily be repositioned under Louise Santos 62, when Louise Santos 62 is repositioned. Instead, another placeholder representation may be left in the hierarchy position from which the Louise Santos representation 62 was moved. The placeholder representation may indicate VP of Marketing, without necessarily indicating a name associated therewith.

Note that each readiness grouping of candidate successors 56-62 according to the readiness indications 70-72 include representations of candidate successors, which are sorted based on each candidates assigned position within the readiness group. Hence, if the Louise Santos 62 representation is repositioned under to 1-2 year readiness indication 72, the representation 62 will be displayed to the right of the Patti Luna representation 58 as Patti is presumed to be “more ready” by virtue of having already been assigned to the 1-2 Years category.

The example user interface controls 104 of the plan details section 82 represent user options to configure whether certain representations of candidate successors in the hierarchy 52 are organized based on job or positions and/or based on incumbents. In certain implementations, when the hierarchy 52 is globally configured for incumbent-based succession, each candidate successor is considered a candidate to replace an incumbent as opposed to a candidate to replace just a position held by an incumbent. In these cases, when an incumbent moves positions within a company, the hierarchy 52 may be automatically updated to indicate that previous candidate successors to the incumbent remain candidate successors to the incumbent. In these cases, the candidate successors are said to follow the incumbent.

By selecting ‘jobs based succession’ via the user interface controls 104, candidate successors 56-62 may be considered candidate successors to all President of Marketing positions existing in an organization or otherwise part of the succession plan corresponding to the succession management hierarchy 52. Hence, the user interface controls 104 represent user options enabling a user to configure a succession management plan associated with the hierarchy 52 to apply to plural positions (e.g., President of Marketing positions) having a similar function as a position specified for the succession management plan associated with the hierarchy 52.

Alternatively, an ‘associate with job’ user option may be selected from the actions drop down menu 78 associated with the Mateo Lopez representation 54. In this case, the candidate successors 56-62 will then be automatically treated as successors to the position held by Mateo Lopez, i.e., President of Marketing, as opposed to successors to Mateo Lopez himself. Hence, if Mateo Lopez is replaced, any of the candidate successors 56-62 may remain candidate successors, if they have not assumed Mateo Lopez's position.

Alternatively, if an ‘associate with incumbent’ user option is selected from the drop down menu 78 associated with the Mateo Lopez representation 54, then candidate successors 56-62 may remain as candidate successors to Mateo Lopez even when Mateo Lopez moves positions.

In a position based implementation of the hierarchy 52, when an incumbent moves positions, existing candidate successors do not necessarily follow the incumbent if the candidate successors have not been previously indicated as candidate successors to the new position to be held by the incumbent. For example, in the position-based configuration, if the incumbent Mateo Lopez, who is currently associated with the representation 54 of the President of Marketing, vacates the position, then the candidate successors 56-62 remain as candidate successors to Mateo Lopez's position 54.

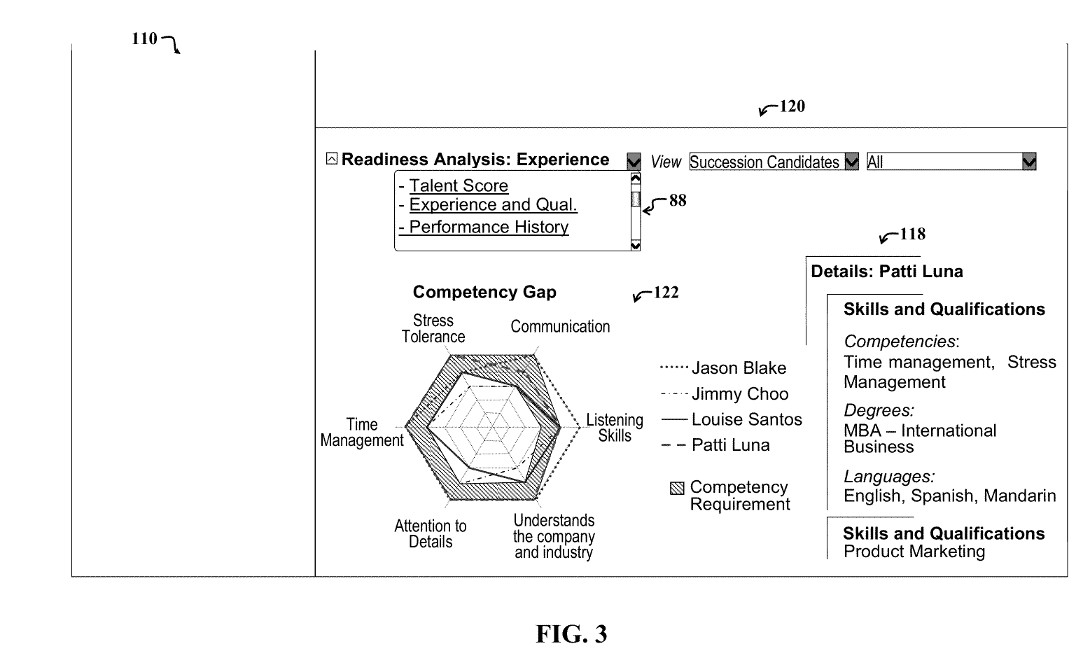

With reference to FIG. 2-3, a readiness analysis section 90, which may be rendered in part via computer code running on the candidate readiness analysis and comparison module 26 of FIG. 1, is shown displaying performance history data, including a performance history graph 92. The performance history graph 92 depicts performance metrics for different years for each candidate successor 56-62, thereby facilitating juxtaposition, comparison, and selection of a candidate to fill an incumbent's position when the incumbent vacates the position.

The performance history graph 92 represents a type of visualization. For the purposes of the present discussion, a visualization may be any graphical representation of data. Other examples of visualizations include pie charts, treemaps, graphs, competency gap graphics, and so on.

An analysis drop-down menu 88 provides various options for displaying different types of analytics and associated data, i.e., insight, pertaining to the candidate successors 56-62. For example, a user may alternatively choose to display experience and qualifications data, talent score data, and so on, pertaining to each candidate successor 56-62.

Note that while in the present embodiment, the displayed data in the readiness analysis section 90 corresponds to all candidate successors 56-62, in certain implementations, the displayed data will only correspond to selected candidate successors. Multiple candidate successors may be selected, for example, by holding down a control key of a keyboard while employing a mouse to click on particular representations of candidate successors 56-62.

Note that while, in the present example embodiment, various representations shown in the hierarchy 52 are associated primarily with names of individuals (e.g., for sorting purposes, and so on) that embodiments are not limited thereto. For example, in certain implementations, various representations of the hierarchy 52 may be primarily associated with positions, where succession readiness determinations are made for positions rather than candidate successors at those positions, without departing from the scope of the present teachings.

FIG. 3 is a diagram of a second example user interface display screen 110 adapted for use with the embodiments of FIGS. 1-2. The second example user interface display screen 110 is similar to the first user interface display screen of FIG. 2 with the exception that a readiness analysis section 120 includes a competency gap graphic and associated competency data 118 for each candidate successor 56-62.

For the purposes of the present discussion, a competency gap graphic may be any illustration or visual representation of data, wherein the data includes one or more values associated with one or more competencies of a resource, such as a human resource. A competency may be any ability or skill.

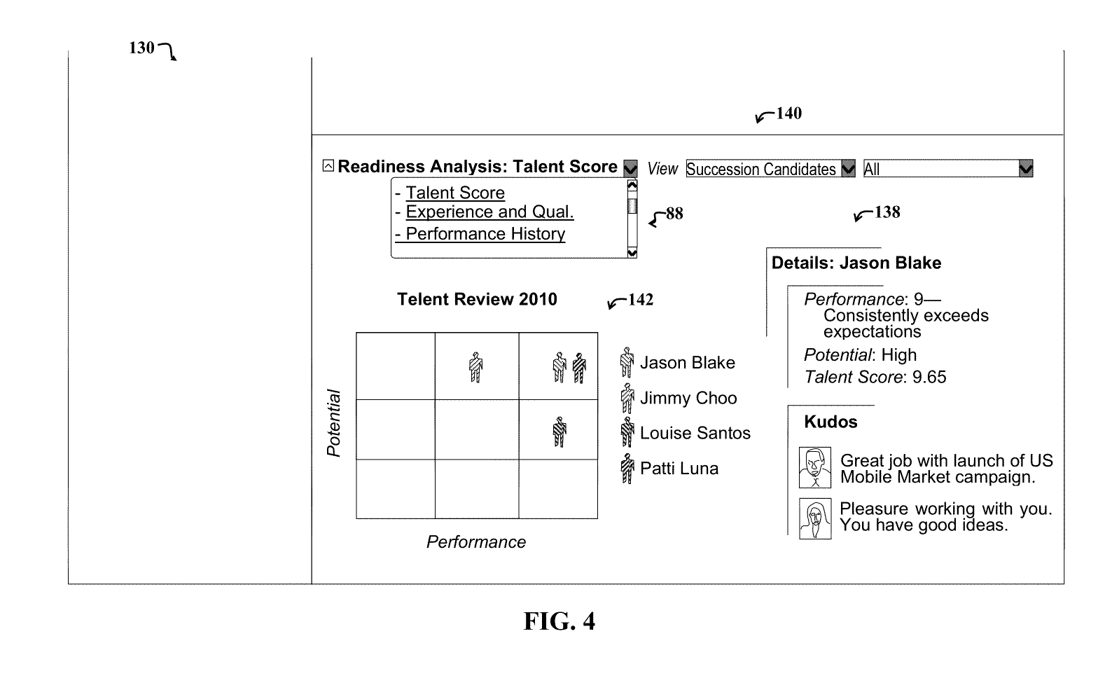

FIG. 4 is a diagram of a third example user interface display screen 130 adapted for use with the embodiments of FIGS. 1-3. The third user interface display screen 130 is similar to the user interface display screens 50, 110 of FIGS. 2 and 3 with the exception that a readiness analysis section 140 includes a 9-box talent score graph 142 and associated talent data 138.

In the present specific embodiment, the talent score graph 142 depicts talent scores for each candidate successor 56-62, wherein each talent score is two dimensional, i.e., includes two components, including a performance component, and a potential component. The graphic 142 depicts positions of the candidate successors 56-62 on a graph of potential versus performance. The potential component corresponds to a potential rating of a candidate successor. Similarly, the performance component refers to a performance rating of a candidate successor. Hence, the talent score graph 142 juxtaposes two-dimensional talent scores for compared candidate successors 56-62.

For the purposes of the present discussion, a potential rating may be any score or metric used to estimate a person's potential or likelihood of progressing to higher levels within a organizational hierarchy of an organization, such as an enterprise. Similarly, a performance score or rating may be any metric used to estimate a person's past performance at an existing position and/or one or more prior positions.

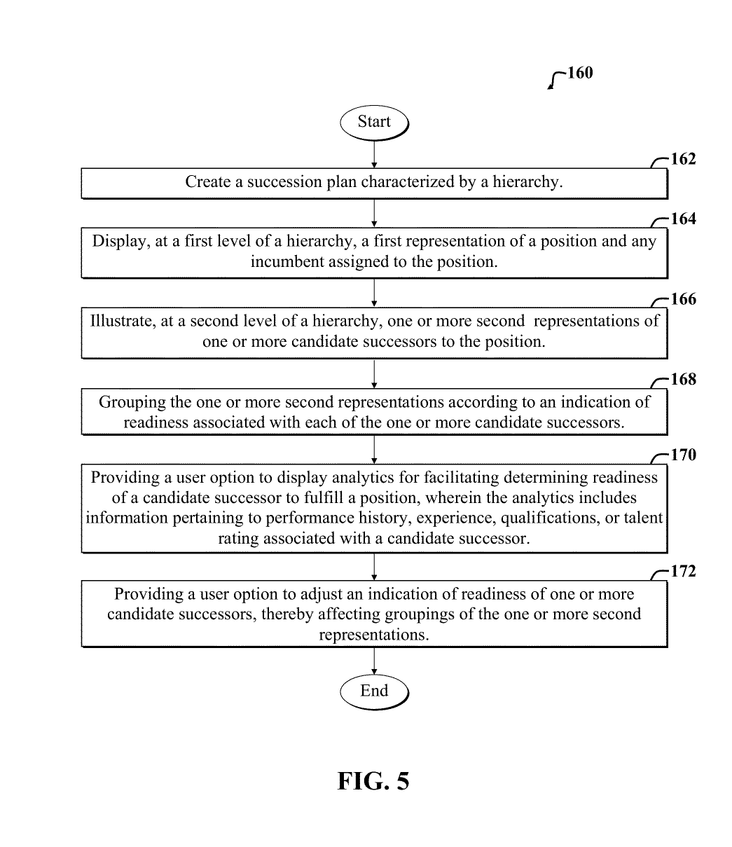

FIG. 5 is a flow diagram of an example method 160 adapted for use with the embodiments of FIGS. 1-4. The example method 160 includes a first step 162, which involves creating a succession plan characterized by a hierarchy.

A second step 164 includes displaying, at a first level of a hierarchy, a first representation of a position and any incumbent assigned to the position.

A third step 166 includes illustrating, at a second level of a hierarchy, one or more second representations of one or more candidate successors to the position.

A fourth step 168 includes grouping the one or more second representations according to an indication of readiness associated with each of the one or more candidate successors.

A fifth step 170 includes providing a user option to display analytics for facilitating determining readiness of a candidate successor to fulfill a position, wherein the analytics includes information pertaining to performance history, experience, qualifications, or talent rating associated with a candidate successor.

A sixth step 172 includes providing a user option to adjust an indication of readiness of one or more candidate successors, thereby affecting groupings of the one or more second representations.

Note that various steps of the method may be altered, augmented, rearranged, or omitted without departing from the scope of the present teachings. For example, in certain implementations the step of providing a user option to adjust indications of readiness may be omitted. Furthermore, certain analytics, e.g., pertaining to performance history, talent scores or ratings, and so on, may be omitted or changed.

Any suitable programming language can be used to implement the routines of particular embodiments including C, C++, Java, assembly language, etc. Different programming techniques can be employed such as procedural or object oriented. The routines can execute on a single processing device or multiple processors. Although the steps, operations, or computations may be presented in a specific order, this order may be changed in different particular embodiments. In some particular embodiments, multiple steps shown as sequential in this specification can be performed at the same time.

Particular embodiments may be implemented in a computer-readable storage medium for use by or in connection with the instruction execution system, apparatus, system, or device. Particular embodiments can be implemented in the form of control logic in software or hardware or a combination of both. The control logic, when executed by one or more processors, may be operable to perform that which is described in particular embodiments.

Particular embodiments may be implemented by using a programmed general purpose digital computer, by using application specific integrated circuits, programmable logic devices, field programmable gate arrays, optical, chemical, biological, quantum or nanoengineered systems, components and mechanisms may be used. In general, the functions of particular embodiments can be achieved by any means as is known in the art. Distributed, networked systems, components, and/or circuits can be used. Communication, or transfer, of data may be wired, wireless, or by any other means.

It will also be appreciated that one or more of the elements depicted in the drawings/figures can also be implemented in a more separated or integrated manner, or even removed or rendered as inoperable in certain cases, as is useful in accordance with a particular application. It is also within the spirit and scope to implement a program or code that can be stored in a machine-readable medium to permit a computer to perform any of the methods described above.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

Thus, while particular embodiments have been described herein, latitudes of modification, various changes, and substitutions are intended in the foregoing disclosures, and it will be appreciated that in some instances some features of particular embodiments will be employed without a corresponding use of other features without departing from the scope and spirit as set forth. Therefore, many modifications may be made to adapt a particular situation or material to the essential scope and spirit.

We claim:

1. A method for facilitating succession management in an organization, the method comprising:
displaying, at a first level of a hierarchy, a first representation of a position and any incumbent assigned to the position; and
illustrating, at a second level of a hierarchy, one or more second representations of one or more candidate successors to the position, wherein the one or more second representations are grouped according to an indication of readiness associated with each of the one or more candidate successors.

2. The method of claim 1, wherein illustrating further includes displaying one or more indications of readiness of a candidate successor.

3. The method of claim 2, wherein the one or more indications of readiness include data pertaining to performance history, experience, qualifications, or talent rating associated with a candidate successor.

4. The method of claim 2, further including displaying candidate successors at the second level of the hierarchy arranged in order of readiness, as indicated via the one or more indications of readiness, within each group of the second level.

5. The method of claim 1, further including providing a first user option to change the indication of readiness associated with a candidate successor by repositioning the candidate successor within the hierarchy.

6. The method of claim 1, further including providing a second user option to associate a candidate with an incumbent such that reassignment of an incumbent to a different position within an organization will result any new succession plan associated with the incumbent including an indication of the candidate as a potential successor to the incumbent.

7. The method of claim 1, further including providing a third user option to associate a candidate with a position, wherein the position may be associated with multiple incumbents.

8. The method of claim 1, further including providing a fourth user option to expand the hierarchy to illustrate a third level, wherein the third level includes third representations of one or more candidate successors to a position held by a candidate successor indicated in the second level of the hierarchy.

9. The method of claim 8, wherein the third representations are grouped according to one or more indications of readiness of one or more candidate successors represented by the third representations.

10. The method of claim 8, wherein the fourth user option further includes a user option to continue to expand the hierarchy to view any level of the hierarchy, wherein subsequent levels of the hierarchy illustrate one or more candidate successors to positions or incumbents held by persons corresponding to representations of candidate successors at a prior level of the hierarchy.

11. The method of claim 1, further including providing a fifth user option to select plural representations of persons displayed in the hierarchy for comparison, and providing comparison data in response thereto.

12. The method of claim 11, further including providing a user option to display comparison data that include data pertaining to experience and qualifications associated with compared candidate successors of the hierarchy.

13. The method of claim 12, wherein displayed data pertaining to experience and qualification includes a competency gap graphic.

14. The method of claim 11, further including providing a user option to display data pertaining to performance history associated with compared candidate successors of the hierarchy.

15. The method of claim 14, wherein the displayed data pertaining to performance history includes a visualization juxtaposing one or more performance metrics associated with each compared candidate successor of the hierarchy.

16. The method of claim 11, further including providing a user option to display data pertaining to one or more talent scores associated with compared candidate successors of the hierarchy.

17. The method of claim 16, wherein the one or more talent scores include a first component representative of a candidate successor's potential rating, and a second component representative of a candidate successor's performance rating, and wherein the displayed data pertaining to one or more talent scores includes a graph of the first component versus the second component for each candidate successor and depicting, on the graph, positions of representations of compared candidate successors.

18. The method of claim 1, further including providing a user option to configure a succession management plan associated with the hierarchy to apply to plural positions having a similar function as a position specified for the succession management plan associated with the hierarchy.

19. An apparatus comprising:
a digital processor coupled to a display and to a processor-readable storage device, wherein the processor-readable storage device includes one or more instructions executable by the digital processor to perform the following acts:
displaying, at a first level of a hierarchy, a first representation of a position and any incumbent assigned to the position; and
illustrating, at a second level of a hierarchy, one or more second representations of one or more candidate successors to the position, wherein the one or more candidate successors are grouped according to an indication of readiness associated with each of the one or more candidate successors.

20. A processor-readable storage device including instructions executable by a digital processor, the processor-readable storage device including one or more instructions for:
displaying, at a first level of a hierarchy, a first representation of a position and any incumbent assigned to the position; and
illustrating, at a second level of a hierarchy, one or more second representations of one or more candidate successors to the position, wherein the one or more candidate successors are grouped according to an indication of readiness associated with each of the one or more candidate successors.
